(19) United States
(12) Patent Application Publication
(10) Pub. No.: US 2026/0197129 A1
(43) Pub. Date: Jul. 9, 2026

(54) TERMINAL AND BASE STATION

(71) Applicant: NTT DOCOMO, INC., Tokyo (JP)

(72) Inventors: Tianyang MIN, Tokyo (JP); Shoki INOUE, Tokyo (JP); Tadashi UCHIYAMA, Tokyo (JP)

(73) Assignee: NTT DOCOMO, INC., Tokyo (JP)

(21) Appl. No.: 18/870,486

(22) PCT Filed: Jun. 10, 2022
(86) PCT No.: PCT/JP2022/023522

§ 371 Date: Nov. 29, 2024

(51) Int. Cl. H04L 5/00

(52) U.S. Cl. CPC H04L 5/0044; H04L 5/0053

(57) ABSTRACT

A terminal includes: a control unit that configures information for configuring a parameter related to a transmission period of DL and UL data transmitted between a terminal and a base station during a predetermined period; and a transmission unit that transmits the information to the base station.

### DESCRIPTION

### Technical Field

The present disclosure relates to a terminal and a base station that support interactive services.

### Background

The 3rd Generation Partnership Project (3GPP: Registered Trademark) has prepared a specification for the 5th generation mobile communication system (which may be called 5G, New Radio (NR), or Next Generation (NG)), and is also in the process of specifying the next generation called Beyond 5G, 5G Evolution, or 6G.

At present, research is underway on an XR (Extended Reality) service that can be realized in an NR network or the like (for example, NON-PATENT LITERATURE 1). XR refers to a complex environment of reality and virtuality generated by a computer.

In the XR service, there is a transmission period in which only DL data such as video traffic is transmitted from a base station to a terminal, and a transmission period (interactive service period) in which DL and UL data are transmitted between a terminal and a base station. In the interactive service period, the generation frequency of UL data is high, and the low latency of UL data is required.

Thus, in order to achieve power saving and low latency in the XR service, it is important to configure a parameter (DRX config, ConfiguredGrantConfig, SPS config, or the like) related to the configuration of an interactive service period in a radio network (base station or the like) at appropriate timing.

### CITATION LIST

### Non-Patent Literature

NON-PATENT LITERATURE 1:3GPP TR 38.838 V 17.0.0 December 2021

### SUMMARY OF THE INVENTION

However, in the conventional art, in some cases, it is difficult for the base station (network) side to understand based on which timing to start an interactive service period or end an interactive service period.

Therefore, the following disclosure has been made in view of such circumstances, and an object of the present disclosure is to provide a terminal and a base station capable of achieving power saving and low latency in interactive services.

An aspect of the present disclosure is a terminal including: a control unit that configures information for configuring a parameter related to a transmission period of DL and UL data transmitted between a terminal and a base station during a predetermined period; and a transmission unit that transmits the information to the base station.

An aspect of the present disclosure is a base station including: a reception unit that receives information for configuring a parameter related to a transmission period of DL and UL data transmitted between a terminal and a base station during a predetermined period; and a control unit that configures the parameter based on the information.

### BRIEF DESCRIPTION OF DRAWINGS

FIG. 1 is an overall schematic diagram of a radio communication system 10 according to a present embodiment.

FIG. 2 is a functional block diagram of gNB 100.

FIG. 3 is a functional block diagram of UE 200.

FIG. 4 is a functional block diagram of AMF 50.

FIG. 5 is a diagram illustrating a transmission and a reception timing of DL data and UL data.

FIG. 6 is a diagram illustrating a transmission and a reception timing of DL data and UL data.

FIG. 7 is a diagram explaining operation example 1.

FIG. 8 is a diagram explaining operation example 2.

FIG. 9 is a diagram explaining operation example 3.

FIG. 10 is a diagram explaining operation example 4.

FIG. 11 is a diagram explaining operation example 5.

FIG. 12 is a diagram explaining operation example 6.

FIG. 13 is a diagram explaining operation example 7.

FIG. 14 is a diagram explaining operation example 8.

FIG. 15 is a diagram illustrating an example of a hardware configuration of the gNB 100, the UE 200, and the AMF 50.

FIG. 16 is a diagram illustrating a configuration example of a vehicle 2001.

### DETAILED DESCRIPTION OF THE INVENTION

An embodiment will be described below with reference to the drawings. Note that the same or similar reference numerals have been attached to the same functions and configurations, and a description thereof will be omitted as appropriate.

### Embodiment

### (1) Overall Schematic Configuration of Radio Communication System 10

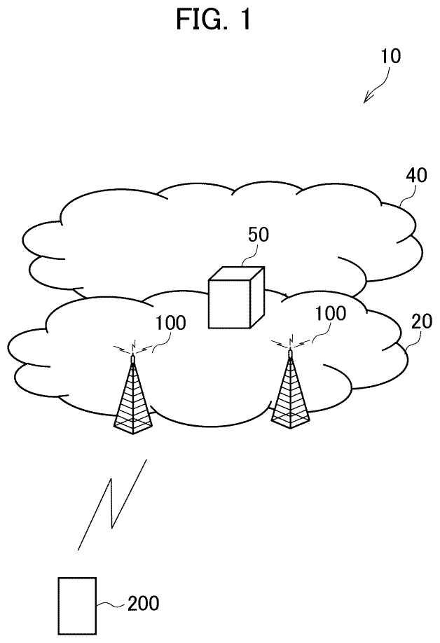

FIG. 1 is an overall schematic diagram of a radio communication system 10 according to a present embodiment. The radio communication system 10 is a radio communication system according to 5G New Radio (NR), and includes a Next Generation-Radio Access Network 20 (hereinafter, referred to as NG-RAN 20) and a head-mounted terminal 200.

The head-mounted terminal 200 is an example of an information terminal worn on the head of a user so as to cover the eyes of the user. The head-mounted terminal 200 is also an example of an information terminal that supports an interactive service such as an XR service.

The head-mounted terminal 200 may be interpreted as an information terminal capable of transmitting and receiving DL data and UL data (DL and UL data) transmitted between the head-mounted terminal 200 and the radio base station 100 during a predetermined period. The head-mounted terminal 200 may be expressed as “UE (User Equipment) 200”, or simply as “terminal 200”.

In addition to a head-mounted information terminal, the UE 200 may include a wearable information terminal such as a watch type, a goggle type, a bracelet type, or a necklace type. The UE 200 may also include an information terminal such as a cellular phone, a portable game machine, a portable information terminal, or an electronic book terminal. The portable information terminal may include a smartphone, a tablet information terminal, or the like.

An interactive service may be interpreted as a CG (Cloud Gaming) service in which information is distributed interactively. The CG service is a service in which operation data indicating the operation of the UE 200 is transmitted to a predetermined server, various game processing is executed in the server, and the execution results are streamed to the UE 200 as video and audio.

The interactive service may be interpreted as a service in which information is distributed interactively, and may include the following services in addition to an XR (Extended Reality) service. For example, in addition to the CG service, the interactive service to which the invention of the present disclosure is applied may include a service in which comments or the like entered by viewers (users of the UE 200) of content distributed from a network are superimposed on the content and displayed, and a service in which viewers can experience as if they were participating in the content distribution.

The interactive service may also be interpreted as a traffic model of DL and UL data for applications such as VR (Virtual Reality) and AR (Augmented Reality).

The radio communication system 10 may be a radio communication system according to a scheme called Beyond 5G, 5G Evolution, or 6G.

The NG-RAN 20 includes a radio base station 100 (hereinafter, gNB 100). The specific configuration of the radio communication system 10 including the number of gNBs and UEs is not limited to the example illustrated in FIG. 1.

The NG-RAN 20 actually includes a plurality of NG-RAN nodes, specifically gNBs (or ng-eNBs), and is connected to a core network 40 (for example, 5GC) according to 5G. The NG-RAN 20 is connected to an access and mobility management function 50 (AMF 50), which is included in a 5G system architecture and provides an access and mobility management function of the UE 200. In addition, a network element other than the radio communication system 10 (for example, a private network (NPN: Non-Public Network) or the like) may be connected to the core network 40.

The gNB 100 is a radio base station according to NR, and performs radio communication with the UE 200 according to NR. Note that the gNB 100 may be configured of a CU (central unit) and a DU (distributed unit), and the DU may be separated from the CU and installed in a geographically different position.

By controlling radio signals transmitted from a plurality of antenna elements, the gNB 100 and the UE 200 can support Massive MIMO that generates a more directional beam BM, carrier aggregation (CA) that uses a plurality of component carriers (CCs) bundled together, dual connectivity (DC) which simultaneously performs communication between the UE 200 and respective NG-RAN nodes, and the like.

In the radio communication system 10, an NRT (Neighbor Relation Table, which may be called Neighbour Cell Relation Table (NCRT)) may be used. The NRT is applied to handover (HO) of the UE 200 to other cells, and manages the identification information of neighboring cells (CGI: Cell Global Identifier). In the NRT, the content may be configured manually in advance, or an Automatic Neighbour Relation (ANR) function, which automatically associates the information between neighboring cells (CGI), may be introduced.

### (2) Function Block Configuration of Radio Communication System

Next, a functional block configuration of the radio communication system 10 will be described. Specifically, the functional block configuration of the gNB 100 and the UE 200 will be described.

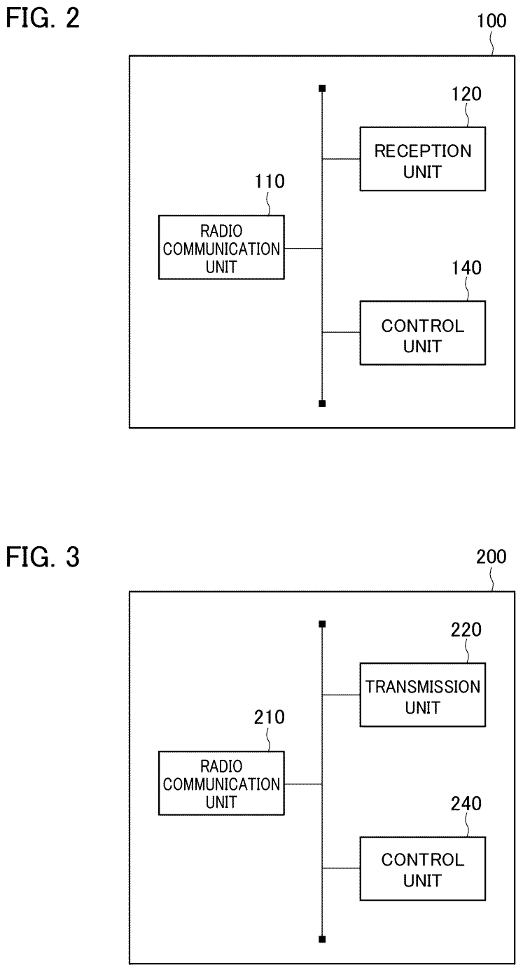

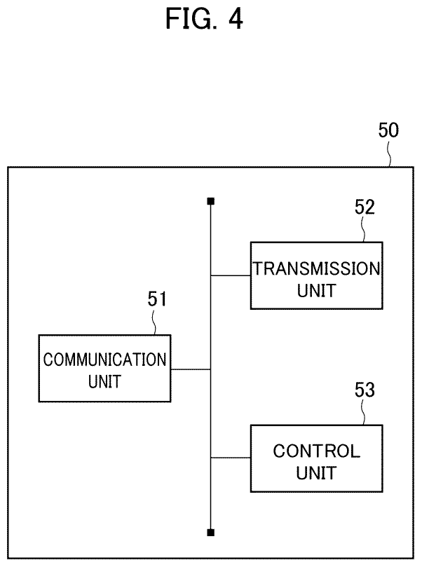

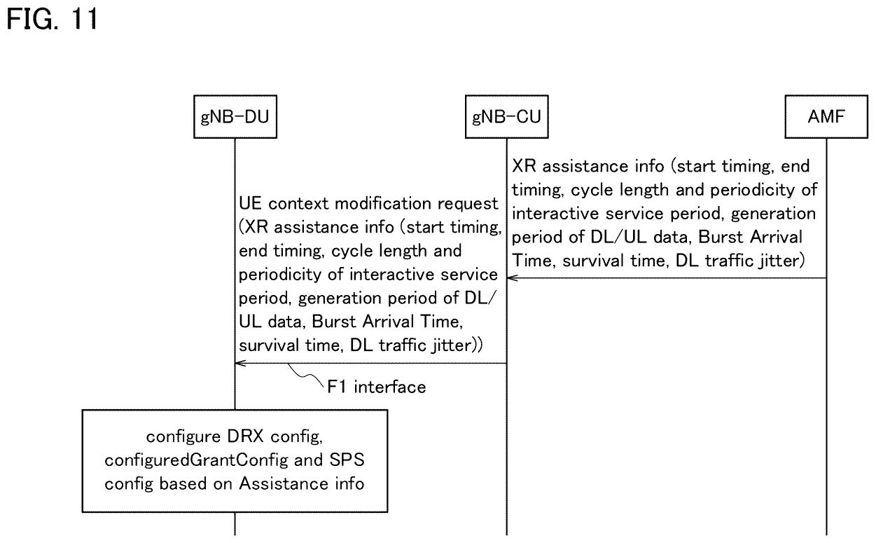

FIG. 2 is a functional block diagram of the gNB 100. FIG. 3 is a functional block diagram of the UE 200. FIG. 4 is a functional block diagram of the AMF 50. Note that only the main functional blocks related to the description of the embodiment are illustrated in FIGS. 2, 3, and 4, and the gNB 100, the UE 200, and the AMF 50 have other functional blocks (for example, a power supply unit). In addition, FIGS. 2, 3, and 4 illustrate the functional block configurations of the gNB 100, the UE 200, and the AMF 50 respectively, and please refer to FIG. 11 for the hardware configuration of these devices.

(2.1) gNB 100

As illustrated in FIG. 2, the gNB 100 includes a radio communication unit 110, a reception unit 120, and a control unit 140.

The radio communication unit 110 transmits a downlink signal (DL signal) according to NR. In addition, the radio communication unit 110 receives an uplink signal (UL signal) according to NR.

The reception unit 120 provides a function of receiving information for configuring a predetermined parameter. Specifically, the reception unit 120 can receive information for configuring a parameter related to a transmission period of DL and UL data transmitted between the UE 200 and the gNB 100 during a predetermined period. The information for configuring a parameter may be expressed simply as “information”, or as “parameter configuration information”. The parameter configuration information may be interpreted as an example of UE assistance info and/or AMF assistance info. The AMF assistance info may be interpreted as XR assistance info.

The parameter configuration information may be transmitted from at least one of the UE 200 and the AMF 50. When the parameter configuration information is transmitted from the UE 200, the reception unit 120 may receive the parameter configuration information transmitted from the UE 200 as the UE assistance info. When the parameter configuration information is transmitted from the AMF 50, the reception unit 120 may receive the parameter configuration information transmitted from the AMF 50.

The predetermined period may be interpreted as a period in which DL and UL data are transmitted between the UE 200 and the gNB 100 in order to provide an interactive service such as an XR (Extended Reality) service. The predetermined period may be interpreted as a transmission period of transmission and reception data related to an interactive service (interactive service period) while the user of the UE 200 is using the interactive service. The predetermined period may be interpreted as a transmission period of data related to the interactive service, except for a transmission period in which only DL data such as video traffic is transmitted from the gNB 100 to the UE 200.

The parameter configuration information may include start timing, end timing, cycle length, periodicity, a generation period of UL data, DL traffic jitter, survival time, and the like.

The start timing may be interpreted as the start time of an interactive service period (a transmission period in which DL and UL data are transmitted between the UE 200 and the gNB 100). The start timing may include the timing described in (1) to (6) below.
(1) The start timing may include the time at which the UE 200 receives DL data, such as video traffic, transmitted in a predetermined transmission period (for example, 16.67 ms). The video traffic is assumed to be a data traffic which is distributed by a streaming service such as a Video on Demand service.
(2) The start timing may include the time at a point in time earlier, by a certain time (for example, 5 ms), than the time at which the UE 200 receives the DL data.
(3) The start timing may include the time at a point in time later, by a certain time (for example, 5 ms), than the time at which the UE 200 receives the DL data.
(4) The start timing may include the transmission time of the first UL data among the UL data transmitted multiple times during an interactive service period.
(5) The start timing may include any time between the transmission time of the UL data and the reception time of the DL data to be received immediately prior to the transmission time.
(6) The start timing may include the time at a point in time later, by a certain time, than the transmission time of the first UL data among the UL data transmitted multiple times during an interactive service period.

The end timing may be interpreted as the end time of an interactive service period. The end timing may include the timing described in (7) to (12) below.
(7) The end timing may include the time at which the UE 200 receives DL data, such as video traffic, transmitted in a predetermined transmission period (for example, 16.67 ms).
(8) The end timing may include the time at a point in time earlier, by a certain time (for example, 5 ms), than the time at which the UE 200 receives the DL data.
(9) The end timing may include the time at a point in time later, by a certain time (for example, 5 ms), than the time at which the UE 200 receives the DL data.
(10) The end timing may include the transmission time of the last UL data among the UL data transmitted multiple times during an interactive service period.
(11) The end timing may include any time between the transmission time of the UL data and the reception time of the DL data to be received immediately after the transmission time.
(12) The end timing may include the time at a point in time eariler, by a certain time, than the transmission time of the last UL data among the UL data transmitted multiple times during an interactive service period.

With respect to the ending timing, the UE 200 may notify the gNB 100 of the ending timing of the interactive service period that is previously notified to the gNB 100 as the timing that is made later by a predetermined offset (X ms) or earlier by a predetermined offset (X ms).

The cycle length may be interpreted as the time indicating the length of an interactive service period. The cycle length may be interpreted as the time equal to the time obtained by multiplying a reception cycle of the DL data (for example, 16.67 ms) by n (n: a natural number of two or more). The cycle length may be interpreted as the time longer than the time obtained by multiplying a reception cycle of the DL data by n, or as the time shorter than the time obtained by multiplying a reception cycle of the DL data by n.

The periodicity may be interpreted as a generation period of multiple UL data (UL data group) transmitted during the cycle length. Specifically, for example, when the multiple UL data is generated at a period of 4 ms, the generation period of the UL data group transmitted at each fixed period may be interpreted as the periodicity. More specifically, when the m-th UL data group (m: a natural number of 1 or more) is generated at a predetermined time and the m+1-th UL data group is generated after a fixed time (for example, after 100 ms), the fixed time (100 ms) may be interpreted as the periodicity.

The periodicity may be interpreted as the time from the time when the first UL data included in the UL data group that is generated at the predetermined time is transmitted until the time when the next UL data group is generated. The periodicity may be interpreted as the time from the time when the last UL data included in the UL data group that is generated at the predetermined time is transmitted until the time when the next UL data group is generated.

The generation period of UL data may be interpreted as the generation period of multiple UL data included in the UL data group that is generated during an interactive service period. Specifically, when multiple UL data is generated in a period of 4 ms, 4 ms may be interpreted as the generation period of UL data.

The DL traffic jitter is the delay of DL traffic that may arrive periodically. Due to fluctuations in the DL traffic, the DL traffic may arrive late, or the DL traffic may arrive early.

The survival time may be interpreted as the time during which the DL data can survive. The survival time may be interpreted as the time during which the DL data becomes invalid and is discarded.

The UE and/or the gNB may include a timer that manages the validity of the data (DL data) in MAC/PDCP entity. In this case, the MAC/PDCP of the UE and/or the gNB may discard the data if, for example, the data has not successfully reached the receiving destination before the timer expires, or if the data has not been successfully transmitted to the lower layer (that is, if there is no Ack from the receiving destination or the lower layer). Further, the timer may start when the data arrives at the MAC/PDCP of the UE and/or the gNB. Furthermore, the timer may stop when the data has successfully arrived, specifically, when a HARQ Ack is received, or when an ACK is received from the lower layer.

The parameter configuration information may be interpreted as the information for configuring at least one of DRX config, CG (ConfiguredGrant) Config, and SPS config. The RX config, CG (ConfiguredGrant) Config, and SPS config are examples of parameters related to the transmission period of DL and UL data transmitted between the UE 200 and the gNB 100 during a predetermined period.

The control unit 140 controls each functional block that constitutes the gNB 100. In particular, in the present embodiment, the control unit 140 can configure a parameter related to a transmission period of DL and UL data transmitted between the UE 200 and the gNB 100 during a predetermined period based on the parameter configuration information received by the reception unit 120.

Specifically, the control unit 140 can configure at least one of DRX config, CG (ConfiguredGrant) Config, and SPS config based on the parameter configuration information from the UE 200, which is received by the reception unit 120.

Further, the control unit 140 can configure at least one of DRX config, CG (ConfiguredGrant) Config, and SPS config based on the parameter configuration information from the AMF 50, which is received by the reception unit 120.

The control unit 140 may include a timer that manages an interactive service period in the MAC and/or RRC entity of the gNB 100. In this case, the control unit 140 may start the count performed by the timer when inputting the interactive play start indication transmitted from the UE 200 via the reception unit 120. The interactive play start indication may be interpreted as an indication indicating that the provision of the interactive service has started, or as an indication announcing that the provision of the interactive service will start. The interactive play start indication may be included in the parameter configuration information.

Further, the control unit 140 may stop the count performed by the timer when inputting the interactive play end indication transmitted from the UE 200 via the reception unit 120. The interactive play end indication may be interpreted as an indication indicating that the provision of the interactive service has ended, or as an indication announcing that the provision of the interactive service will end. The interactive play end indication may be included in the parameter configuration information.

Further, the control unit 140 may assume that the interactive service has ended when the timer expires.

Further, the control unit 140 may configure the DRX config according to the information such as preferredDRX-InactivityTimer, preferredDRX-LongCycle, preferredDRX-ShortCycle, and preferredDRX-ShortCycleTimer during the interactive service period. This information may be included in the parameter configuration information.

The preferredDRX-InactivityTimer represents the length of DRX inactivity time (1 ms, 2 ms, or the like) that is prioritized for power saving of the UE 200 (see, for example, 3GPP TS 38.331 V 17.0.0 (2022-03)).

The preferredDRX-LongCycle represents the length of a relatively long DRX cycle (10 ms, 20 ms, or the like) that is prioritized for power saving of the UE 200. When the preferredDRX-ShortCycle is applied, the value of preferredDRX-LongCycle may be a multiple of the value of preferredDRX-ShortCycle (see, for example, 3GPP TS 38.331 V17.0.0 (2022-03)).

The preferredDRX-ShortCycle represents the length of a relatively short DRX cycle (2 ms, 3 ms, or the like) that is prioritized for power saving of the UE 200 (see, for example, 3GPP TS 38.331 V 17.0.0 (2022-03)).

The preferredDRX-ShortCycleTimer represents the timer of preferredDRX-ShortCycle, and may be specified as a multiple of preferredDRX-ShortCycle (see, for example, 3GPP TS 38.331 V 17.0.0 (2022-03)).

The parameter configured in the control unit 140 is not limited to the DRX config, the CG (ConfiguredGrant) Config, and the SPS config, and it is possible to include other parameters capable of achieving power saving and low latency of the UE 200 in an interactive service such as an XR service.

### (2.2) UE 200

As illustrated in FIG. 3, the UE 200 includes a radio communication unit 210, a transmission unit 220, and a control unit 240.

The radio communication unit 210 transmits an uplink signal (UL signal) according to NR. The radio communication unit 210 also receives an uplink signal (DL signal) according to NR.

The control unit 240 controls each functional block that constitutes the UE 200. In particular, in the present embodiment, the control unit 240 can configure information (parameter configuration information) for configuring a parameter related to a transmission period of DL and UL data transmitted between the UE 200 and the gNB 100 during a predetermined period.

The transmission unit 220 provides a function for transmitting information for configuring a predetermined parameter. Specifically, the transmission unit 220 transmits the parameter configuration information to the gNB 100 as UE assistance info. More specifically, the transmission unit 220 may transmit to the gNB 100, the parameter configuration information which may include the start timing, the end timing, the cycle length, the periodicity, a generation period of the UL data, the survival time, and the like described above.

At the time of the interactive service period start, the transmission unit 220 may transmit the interactive play start indication described above as the parameter configuration information to the gNB 100. This allows the UE 200 to directly notify the gNB 100 that the provision of the interactive service has started without relying on the notification from the AMF 50 to the gNB 100.

Further, at the time of the interactive service period end, the transmission unit 220 may transmit the interactive play end indication described above as the parameter configuration information to the gNB 100. This allows the UE 200 to directly notify the gNB 100 that the provision of the interactive service has ended without relying on the notification from the AMF 50 to the gNB 100.

Incidentally, when the UE 200 detects that the interactive service has started due to a user's movement, a user's pose (user's gesture) or the like, the transmission unit 220 may transmit the interactive play start indication to the gNB 100 as the parameter configuration information.

Further, when the UE 200 detects that the interactive service has started by a notification from the application layer to the AS (Access Stratum) layer in the UE 200, the transmission unit 220 may transmit the interactive play start indication to the gNB 100 as the parameter configuration information.

For transmitting the parameter configuration information from the UE 200 to the gNB 100, PUCCH, MAC CE, RRC message (RRCReconfiguration message), UEAssistanceInformation message, or the like may be used.

The transmission unit 220 of the UE 200 may transmit feedback to the gNB 100 about the DRX/CG/SPS config configured in the gNB 100. Specifically, the UE 200 may feedback request information requesting that the timing of the DRX/CG/SPS config that is configured be earlier by a predetermined offset (X ms), request information requesting that the timing thereof be later by an offset (X ms), information indicating that the timing is good for the UE, or the like. In addition, the transmission unit 220 of the UE 200 may transmit information related to a suggestion for activating and/or deactivating the DRX config to the gNB 100.

The UE 200 may include a timer similar to the timer provided in the gNB 100. Specifically, the control unit 240 of the UE 200 may include a timer that manages the interactive service period in the MAC and/or RRC entity of the UE 200.

In this case, for example, when the provision of the interactive service starts, the control unit 240 may start the count performed by the timer. When the counting starts, the transmission unit 220 transmits an interactive play start indication to the gNB 100.

Further, in this case, the control unit 240 may stop the count performed by the timer when the provision of the interactive service ends. When the counting stops, the transmission unit 220 transmits an interactive play end indication to the gNB 100.

The transmission unit 220 of the UE 200 may transmit request information requesting the configuration of the length of the preferred interactive service period timer to the gNB 100. Specifically, the transmission unit 220 of the UE 200 may transmit to the gNB 100, request information requesting that the length of the preferred interactive service period timer be increased, request information requesting that the length of the preferred interactive service period timer be decreased, or the like.

Further, the transmission unit 220 of the UE may transmit to the gNB 100, request information requesting that the length of the interactive service period timer be increased, request information requesting that the length of the interactive service period timer be decreased, or the like.

When the interactive service period ends, the control unit 240 may autonomously adjust an intermittent reception cycle in the transmission period (interactive service period). Specifically, when the interactive service period ends, the control unit 240 may autonomously transition to the long DRX cycle (preferredDRX-LongCycle). More specifically, when the timer expires, the control unit 240 may autonomously transition from the preferredDRX-ShortCycle to the preferredDRX-LongCycle. Further, when the interactive service period ends (timer expires) even before the preferredDRX-InactivityTimer expires, the control unit 240 of the UE 200 may autonomously transition to the long DRX cycle (preferredDRX-LongCycle).

When the interactive service period ends, the control unit 240 may adjust an intermittent reception cycle in the transmission period (interactive service period) based on the MAC CE transmitted from the gNB 100. Specifically, when the interactive service period ends, the control unit 240 transmits an indication indicating the end of the interactive service (interactive play end indication) to the gNB 100 via the transmission unit 220. Upon receiving this indication, the gNB 100 transmits a long DRX command MAC CE to the UE 200. Thus, the control unit 240 of the UE 200 that has received the long DRX command MAC CE may transition to the preferredDRX-LongCycle. Specifically, the control unit 240 may transition from the preferredDRX-ShortCycle to the preferredDRX-LongCycle.

The transmission unit 220 of the UE may transmit request information requesting to enter (transition to) the DRX to the gNB 100.

When performing DC (Dual Connectivity) between the MN and the SN, the UE 200 may transmit the parameter configuration information to the MN. In this case, the MN may transmit the received parameter configuration information to the SN. The MN may transmit the parameter configuration information to the SN using an SN addition request message, an SN modification request message, or the like. Further, if the gNB 100 is a Split gNB, the CU (gNB-CU) that has received the parameter configuration information from the UE 200 may transmit the parameter configuration information to the DU (gNB-DU) via the F1 interface. Further, the CU (gNB-CU) that has received the parameter configuration information from the UE 200 may transmit the parameter configuration information to the DU (gNB-DU) via the F1 interface using a UE context modification request message. Further, if the gNB-CU is split into the gNB-CU-CP and the gNB-CU-UP, the gNB-CU-CP that has received the parameter configuration information from the UE 200 may transmit the parameter configuration information to the gNB-CU-UP using a bearer context setup request, or a bearer context modification request message.

If a handover from the S-gNB to the T-gNB is performed by the UE 200 moving from the source node (S-gNB) to the target node (T-gNB), the UE 200 may transmit the parameter configuration information to the S-gNB. In this case, the S-gNB may transmit the received parameter configuration information to the T-gNB. The source node (S-gNB) may transmit the parameter configuration information to the T-gNB using a HandoverPreparationInformation message or a Handover request message.

Note that instead of the UE 200 transmitting the parameter configuration information to the S-gNB, the AMF 50 may transmit a Path switch request ack to the target node as the parameter configuration information.

### (2.3) AMF 50

As illustrated in FIG. 4, the AMF 50 includes a communication unit 51, a transmission unit 52, and a control unit 53.

The communication unit 51 transmits a signal to the gNB 100 and receives a signal transmitted from the gNB 100.

The control unit 53 controls each functional block that constitutes the AMF 50. In particular, in the present embodiment, the control unit 53 can configure information (parameter configuration information) for configuring a parameter related to a transmission period of DL and UL data transmitted between the UE 200 and the gNB 100 during a predetermined period.

Similar to the transmission unit 22 of the UE 200, the transmission unit 52 provides a function of transmitting information for configuring a predetermined parameter. Specifically, the transmission unit 52 transmits the parameter configuration information to the gNB 100 as UE assistance info. More specifically, the transmission unit 52 may transmit to the gNB 100, the parameter configuration information which may include the start timing, the end timing, the cycle length, the periodicity, a generation period of the UL data, the survival time, and the like described above.

Further, in addition to the parameter configuration information described above, the transmission unit 52 may transmit to the gNB 100, a generation period of DL data, Burst arrival time, DL traffic jitter (at least one of a maximum value, a minimum value, and an average value), and the like as AMF assistance info (XR assistance info).

The Burst arrival time may be interpreted as the arrival time of DL data to the UE 200. The DL traffic jitter may be interpreted as the reception time difference between the DL data received at a predetermined time and the DL data received at a time deviated by a certain time from the predetermined time. The Burst arrival time and the DL traffic jitter may be transmitted from the UPF to the gNB instead of the AMF 50.

If the gNB 100 is a Split gNB, the CU (gNB-CU) that has received the parameter configuration information from the AMF 50 may transmit the parameter configuration information to the DU (gNB-DU) via the F1 interface. Further, the CU (gNB-CU) that has received the parameter configuration information from the AMF 50 may transmit the parameter configuration information to the DU (gNB-DU) via the F1 interface using a UE context modification request message. Further, if the gNB-CU is split into the gNB-CU-CP and the gNB-CU-UP, the gNB-CU-CP that has received the parameter configuration information from the AMF 50 may transmit the parameter configuration information to the gNB-CU-UP using a bearer context setup request or a bearer context modification request message.

### (3) Operation of Radio Communication System

Next, an operation of the radio communication system 10 will be described. Specifically, a description will be given to an operation example of the radio communication system 10 that achieves power saving and low latency in an interactive service such as an XR service.

### (3.1) Assumption and Problem

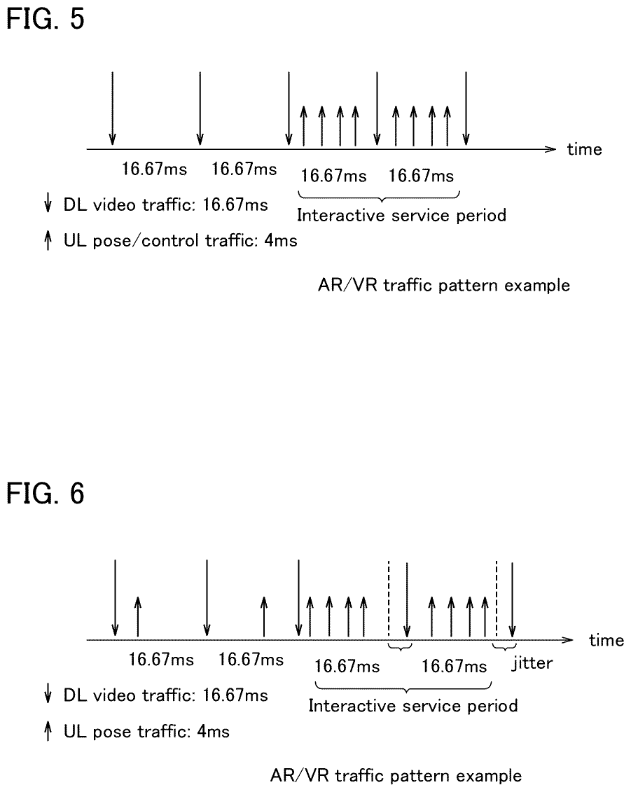

With reference to FIGS. 5 and 6, a description will be given to a problem in configuring a parameter (DRX config, ConfiguredGrantConfig, SPS config, or the like) related to the configuration of an interactive service period at appropriate timing.

FIGS. 5 and 6 are diagrams illustrating a transmission and a reception timing of DL data and UL data. As illustrated in FIG. 5, in the XR service, there may be a transmission period (for example, 16.67 ms) in which only DL data such as video traffic is transmitted from the gNB 100 to the UE 200, and a transmission period (interactive service period) in which DL and UL data are transmitted between the UE 200 and the gNB 100. In the latter transmission period (interactive service period), the generation frequency of UL data (pose, gesture, control data, or the like) is high, and low latency of UL data is also required. Thus, in order to achieve power saving and low latency in the XR service, it is important to configure a parameter (DRX config, ConfiguredGrantConfig, SPS config, or the like) related to the configuration of an interactive service period at appropriate timing in the radio network. For example, by appropriately configuring the time at which the transmission of the first UL data group starts after the UE 200 receives the third DL data from the left side in FIG. 5, the needs for low latency can be satisfied while saving the power of the UE 200.

However, in the conventional art, a criteria for appropriately configuring the parameter is not clear. Therefore, in the interactive service, in some cases, it is difficult for the gNB 100 to determine based on which timing to start an interactive service period or end an interactive service period.

In particular, when the XR game server generates a DL video frame based on the user's updated position, velocity, or the like during an interactive play period, DL traffic jitter may be generated in the DL data. Specifically, as illustrated in the fourth DL data from the left side in FIG. 6, the reception timing of the DL data to the UE 200 deviates to the right side in FIG. 6. If the DL traffic jitter is generated in this way, it may become more difficult for the gNB 100 to determine based on which timing to start an interactive service period or end an interactive service period, which may cause a problem in how the gNB 100 configures the DRX config, the SPS config, or the like after recognizing such jitter.

Therefore, the following solutions are considered.
(1) The UE 200 may transmit the parameter configuration information (start timing, end timing, cycle length, periodicity, a generation period of UL data, survival time, and the like), which is information for configuring a predetermined parameter, to the gNB 100 as UE assistance info.
(2) The AMF 50 may transmit the parameter configuration information (start timing, end timing, cycle length, periodicity, a generation period of UL data, survival time, a generation period of DL data, Burst arrival time, DL traffic jitter, and the like), which is information for configuring a predetermined parameter, to the gNB 100 as AMF assistance info (XR assistance info).

### (3.2) Operation Examples

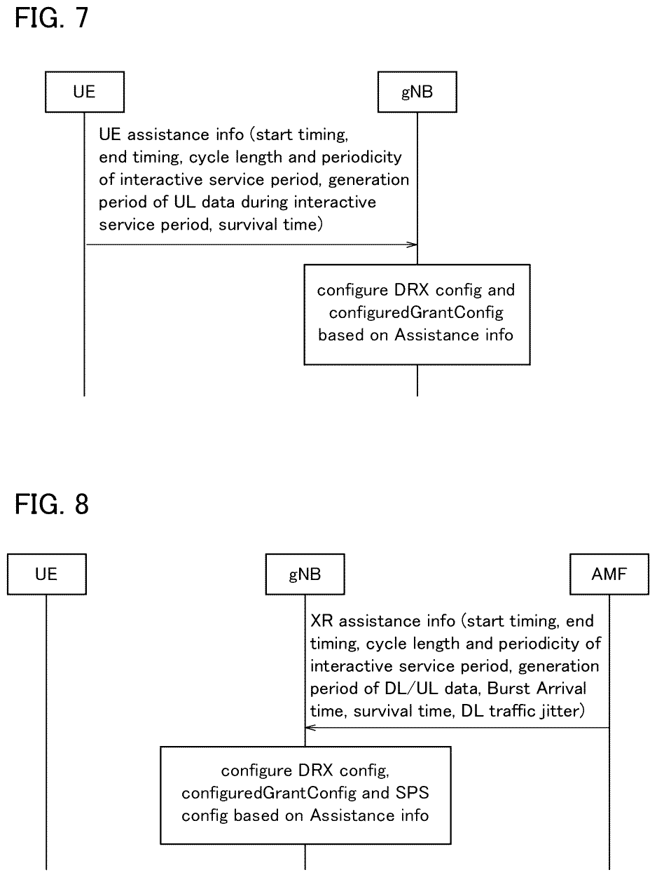

With reference to FIGS. 7 to 14, a description will be given to operation examples in which a parameter related to the configuration of an interactive service period may be configured at appropriate timing.

### (3.2.1) Operation Example 1

In operation example 1, when an interactive service is provided, the parameter configuration information configured in the UE 200 is received by the gNB 100 as UE assistance info. FIG. 7 is a diagram explaining the operation example 1. In FIG. 7, an operation when configuring the DRX config or the like based on the UE assistance info will be described. As illustrated in FIG. 7, the UE 200 transmits the parameter configuration information to the gNB 100 as the UE assistance info. Upon receiving the UE assistance info, the gNB 100 can configure at least one of the DRX config, CG (ConfiguredGrant) Config, and SPS config based on the UE assistance info.

### (3.2.2) Operation Example 2

In operation example 2, when an interactive service is provided, the parameter configuration information configured in the AMF 50 is received by the gNB 100 as AMF assistance info (XR assistance info). FIG. 8 is a diagram explaining the operation example 2. In FIG. 8, an operation when configuring the DRX config or the like based on the AMF assistance info will be described. As illustrated in FIG. 8, the AMF 50 transmits the parameter configuration information to the gNB 100 as the AMF assistance info. Upon receiving the AMF assistance info, the gNB 100 can configure at least one of the DRX config, CG (ConfiguredGrant) Config, and SPS config based on the AMF assistance info.

### (3.2.3) Operation Example 3

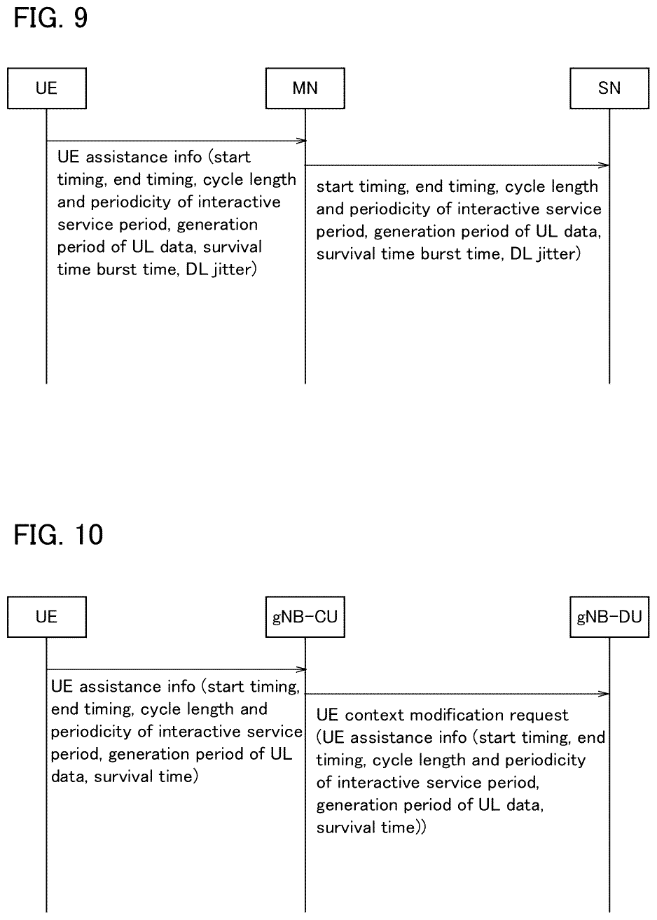

In operation example 3, in a case where the UE 200 performs DC (Dual Connectivity) between the MN and the SN when an interactive service is provided, the parameter configuration information configured in the UE 200 is received by the SN via the MN. FIG. 9 is a diagram explaining the operation example 3. In FIG. 9, an operation when the SN, which has received the UE assistance info via the MN, configures the DRX config or the like based on the UE assistance info will be described. As illustrated in FIG. 9, when the MN receives the parameter configuration information which is the UE assistance info transmitted from the UE 200, the MN may transmit the received parameter configuration information to the SN. Thus, the SN can configure at least one of the DRX config, CG (ConfiguredGrant) Config, and SPS config based on the parameter configuration information.

### (3.2.4) Operation Example 4

In operation example 4, when an interactive service is provided, the parameter configuration information configured in the UE 200 is received by a DU (Distributed Unit) via a CU (Central Unit). FIG. 10 is a diagram explaining the operation example 4. As illustrated in FIG. 10, in the case of a so-called Split gNB in which the gNB 100 is configured of the CU and the DU, the DU may be separated from the CU and installed in a geographically different position. In FIG. 10, an operation in which the DU, which has received the UE assistance info via the CU, configures the DRX config or the like based on the UE assistance info will be described. As illustrated in FIG. 10, when the CU receives the parameter configuration information which is the UE assistance info transmitted from the UE 200, the CU may transmit the received parameter configuration information to the DU. Thus, the DU can configure at least one of the DRX config, CG (ConfiguredGrant) Config, and SPS config based on the parameter configuration information.

### (3.2.5) Operation Example 5

In operation example 5, when an interactive service is provided, the parameter configuration information configured in the AMF 50 is received by the DU (gNB-DU) via the CU (gNB-CU). FIG. 11 is a diagram explaining the operation example 5. As illustrated in FIG. 11, in the case of a so-called Split gNB in which the gNB 100 is configured of the CU and the DU, the DU may be separated from the CU and installed in a geographically different position. In FIG. 11, an operation in which the DU, which has received the XR assistance info via the CU, configures the DRX config or the like based on the XR assistance info will be described. As illustrated in FIG. 11, when the CU receives the parameter configuration information which is the XR assistance info transmitted from the AMF 50, the CU may transmit the received parameter configuration information to the DU. Thus, the DU can configure at least one of the DRX config, CG (ConfiguredGrant) Config, and SPS config based on the parameter configuration information.

### (3.2.6) Operation Example 6

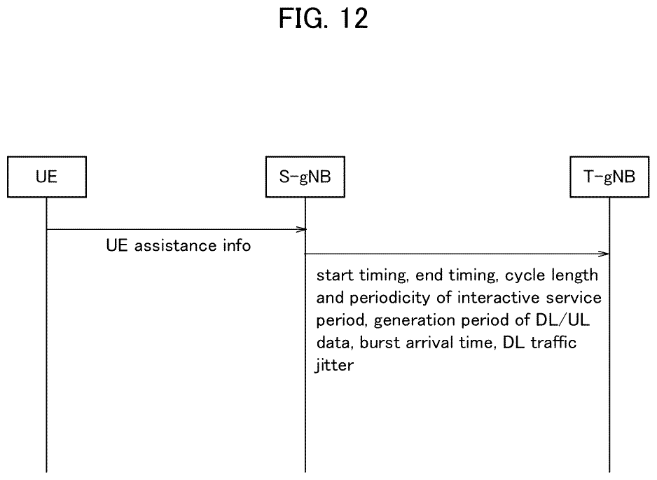

In operation example 6, in a case where the UE 200 moves from the source node (S-gNB) to the target node (T-gNB) to perform a handover from the S-gNB to the T-gNB when an interactive service is provided, the parameter configuration information configured in the UE 200 is received by the T-gNB via the S-gNB. FIG. 12 is a diagram explaining the operation example 6. In FIG. 12, an operation when the T-gNB, which has received the UE assistance info via the S-gNB, configures the DRX config or the like based on the UE assistance info will be described. As illustrated in FIG. 12, when the S-gNB receives the parameter configuration information which is the UE assistance info transmitted from the UE 200, the S-gNB may transmit the received parameter configuration information to the T-gNB. Thus, the T-gNB can configure at least one of the DRX config, CG (ConfiguredGrant) Config, and SPS config based on the parameter configuration information.

### (3.2.7) Operation Example 7

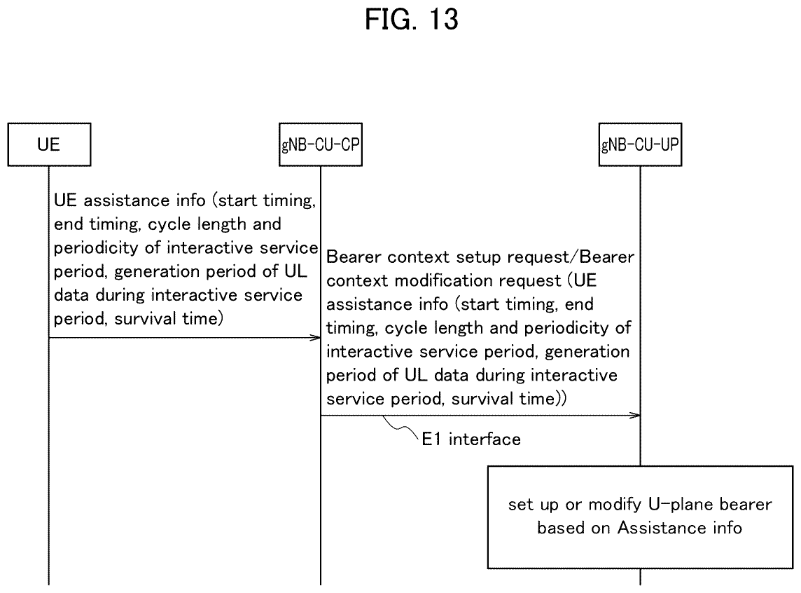

In operation example 7, when an interactive service is provided, the parameter configuration information configured in the UE 200 is received by the gNB-CU-UP via the gNB-CU-CP. FIG. 13 is a diagram explaining the operation example 7. As illustrated in FIG. 13, when the gNB-CU is split into the gNB-CU-CP and the gNB-CU-UP, the gNB-CU-UP may be separated from the gNB-CU-CP and installed in a geographically different position. In FIG. 13, an operation when the gNB-CU-UP, which has received the UE assistance info via the gNB-CU-CP, configures the setup of a U-plane bearer or the modification of a U-plane bearer based on the UE assistance info will be described. As illustrated in FIG. 13, when the gNB-CU-CP receives the parameter configuration information which is the UE assistance info transmitted from the UE 200, the gNB-CU-CP may transmit the received parameter configuration information to the gNB-CU-UP. Thus, the gNB-CU-UP sets up the U-plane bearer or modifies the U-plane bearer based on the parameter configuration information. In addition, the gNB-CU-UP can configure at least one of the DRX config, CG (ConfiguredGrant) Config, and SPS config based on the parameter configuration information.

### (3.2.8) Operation Example 8

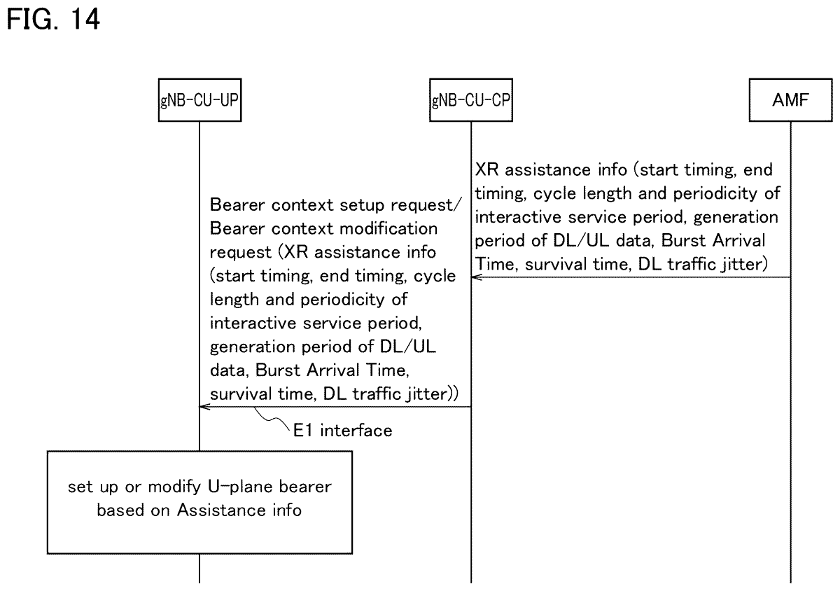

In operation example 8, when an interactive service is provided, the parameter configuration information configured in the AMF 50 is received by the gNB-CU-UP via the gNB-CU-CP. FIG. 14 is a diagram explaining the operation example 8. As illustrated in FIG. 14, when the gNB-CU is split into the gNB-CU-CP and the gNB-CU-UP, the gNB-CU-UP may be separated from the gNB-CU-CP and installed in a geographically different position. In FIG. 14, an operation when the gNB-CU-UP, which has received the XR assistance info via the gNB-CU-CP, configures the setup of a U-plane bearer or the modification of a U-plane bearer based on the XR assistance info will be described. As illustrated in FIG. 14, when the gNB-CU-CP receives the parameter configuration information which is the XR assistance info transmitted from the AMF 50, the gNB-CU-CP may transmit the received parameter configuration information to the gNB-CU-UP. Thus, the gNB-CU-UP sets up the U-plane bearer or modifies the U-plane bearer based on the parameter configuration information. In addition, the gNB-CU-UP can configure at least one of the DRX config, CG (ConfiguredGrant) Config, and SPS config based on the parameter configuration information.

### (4) Operation and Effect

According to the embodiment described above, the following operation and effect are obtained. Specifically, the UE 200 according to the embodiment of the present disclosure includes: a control unit that configures information for configuring a parameter related to a transmission period of DL and UL data transmitted between the UE 200 and the gNB 100 during a predetermined period; and a transmission unit that transmits the information to the gNB 100.

This configuration makes it possible to notify the RAN node of the assistance info from the UE 200 in advance about the data characteristics during the interactive service period in which power saving and low latency are required. Therefore, the RAN node can appropriately configure the DRX config, SPS config, or the like, and is expected to achieve the requirements for power saving and low latency in the XR service. It is also possible to meet the needs for power saving specific to XR corresponding to XR service characteristics (periodicity, multiple flows, jitter, latency, reliability, etc.).

Further, the gNB 100 according to the embodiment of the present disclosure includes: a reception unit that receives information for configuring a parameter related to a transmission period of DL and UL data transmitted between the UE 200 and the gNB 100 during a predetermined period; and a control unit that configures a parameter based on the information.

This configuration makes it possible for the gNB 100 to understand in advance the assistance info from the AMF 50, the UE 200, or the like about the data characteristics during the interactive service period in which power saving and low latency are required. Therefore, the gNB 100 can appropriately configure the DRX config, SPS config, or the like, and is expected to achieve the requirements for power saving and low latency in the XR service.

### (5) Other Embodiments

Although the embodiment has been described as above, the present disclosure is not limited to the description of the embodiment, and it is obvious to those skilled in the art that various modifications and improvements are possible.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

In the present disclosure, the terms such as “precoding”, “precoder”, “weight (precoding weight)”, “quasi-co-location (QCL)”, “Transmission Configuration Indication state (TCI state)”, “spatial relation”, “spatial domain filter”, “transmission power”, “phase rotation”, “antenna port”, “antenna port group”, “layer”, “the number of layers”, “rank”, “resource”, “resource set”, “resource group”, “beam”, “beam width”, “beam angular degree”, “antenna”, “antenna element”, “panel”, and so on can be used interchangeably.

The block diagram (FIGS. 2, 3 and 4) used in the description of the above-described embodiment illustrates blocks in units of functions. Those functional blocks (components) can be realized by any combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as described above, the realization method is not particularly limited.

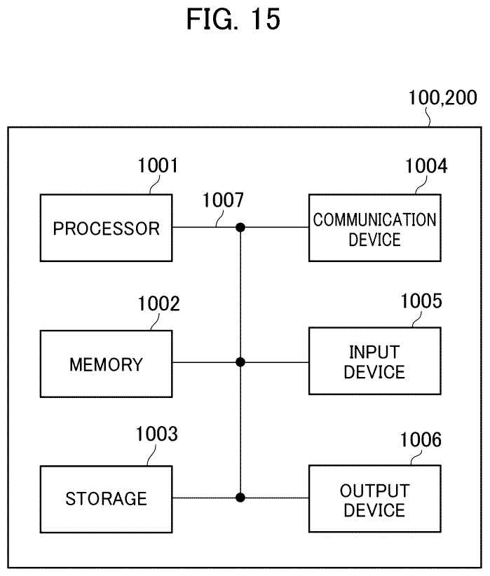

Further, the above-described gNB 100, UE 200 and AMF 50 (the devices) may function as a computer that performs processing of a radio communication method of the present disclosure. FIG. 15 is a diagram illustrating an example of a hardware configuration of gNB 100, UE 200 and AMF 50. As illustrated in FIG. 15, the devices may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the devices (FIGS. 2, 3 and 4) is implemented by means of any of hardware elements of the computer device or a combination of the hardware elements.

Each function in the devices is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 operates, for example, an operating system to control the entire computer. The processor 1001 may be configured with a central processing unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and executes various processes according to these. As the program, a program causing the computer to execute at least part of the operation described in the above embodiment is used. Alternatively, various processes described above may be executed by one processor 1001 or may be executed simultaneously or sequentially by two or more processors 1001. The processor 1001 may be implemented by using one or more chips. Alternatively, the program may be transmitted from a network via a telecommunication line.

The memory 1002 is a computer readable recording medium and may be configured, for example, with at least one of a Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can execute the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (registered trademark) disk), a smart card, a flash memory (for example, a card, a stick, a key drive), a floppy (registered trademark) disk, a magnetic strip, and the like. The storage 1003 may be referred to as an auxiliary storage device. The recording medium may be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also referred to as, for example, a network device, a network controller, a network card, a communication module, and the like.

The communication device 1004 may include a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may have an integrated configuration (for example, a touch screen).

Also, the respective devices such as the processor 1001 and the memory 1002 are connected to each other with the bus 1007 for communicating information. The bus 1007 may be constituted by a single bus or may be constituted by different buses for each device-to-device.

Further, the device may be configured to include hardware such as a microprocessor, a Digital Signal Processor (DSP), an Application Specific Integrated Circuit (ASIC), a Programmable Logic Device (PLD), and a Field Programmable Gate Array (FPGA). Some or all of these functional blocks may be realized by means of this hardware. For example, the processor 1001 may be implemented by using at least one of the above-described items of hardware.

Further, notification of information is not limited to that in the aspect/embodiment described in the present disclosure, and may be performed by using other methods. For example, notification of information may be performed by physical layer signaling (for example, Downlink Control Information (DCI), Uplink Control Information (UCI), higher layer signaling (for example, RRC signaling, Medium Access Control (MAC) signaling), broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each aspect/embodiment described in the present disclosure may be applied to at least one of Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and a next-generation system that is expanded based on these. Further, a plurality of systems may be combined (for example, a combination of at least one of LTE and LTE-A with 5G) and applied.

The order of the processing procedures, sequences, flowcharts, and the like of each aspect/embodiment described in the present disclosure may be exchanged as long as there is no contradiction. For example, the methods described in the present disclosure present the elements of the various steps by using an exemplary order and are not limited to the presented specific order.

The specific operation that is performed by a gNB 100 in the present disclosure may be performed by its upper node in some cases. In a network constituted by one or more network nodes having a gNB 100, it is obvious that the various operations performed for communication with the terminal may be performed by at least one of the gNB 100 and other network nodes other than the gNB 100 (for example, an MME, an S-GW, and the like may be considered, but there is not limited thereto). In the above, an example in which there is one network node other than the gNB 100 is explained; however, a combination of a plurality of other network nodes (for example, an MME and an S-GW) may be used.

Information and signals (information and the like) can be output from a higher layer (or lower layer) to a lower layer (or higher layer). These may be input and output via a plurality of network nodes.

The input/output information may be stored in a specific location (for example, a memory) or may be managed in a management table. The information to be input/output can be overwritten, updated, or added. The information may be deleted after outputting. The inputted information may be transmitted to another device.

The determination may be made by using a value (0 or 1) represented by one bit, by truth-value (Boolean: true or false), or by comparison of numerical values (for example, comparison with a predetermined value).

Each of the aspects/embodiment described in the present disclosure may be used separately or in combination, or may be switched in accordance with the execution. In addition, notification of predetermined information (for example, notification of “is X”) is not limited to being performed explicitly, and it may be performed implicitly (for example, without notifying the predetermined information).

Regardless of being referred to as software, firmware, middleware, microcode, hardware description language, or some other name, software should be interpreted broadly to mean instructions, an instruction set, code, a code segment, program code, a program, a subprogram, a software module, an application, a software application, a software package, a routine, a subroutine, an object, an executable file, an execution thread, a procedure, a function, and the like.

Further, software, instruction, information, and the like may be transmitted and received via a transmission medium. For example, when software is transmitted from a website, a server, or another remote source by using at least one of a wired technology (a coaxial cable, an optical fiber cable, a twisted pair cable, a Digital Subscriber Line (DSL), or the like) and a wireless technology (infrared light, microwave, or the like), then at least one of these wired and wireless technologies is included within the definition of the transmission medium.

Information, signals, or the like described in the present disclosure may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or any combination thereof.

It should be noted that the terms described in the present disclosure and terms necessary for understanding the present disclosure may be replaced with terms having the same or similar meanings. For example, at least one of a channel and a symbol may be a signal (signaling). A signal may also be a message. Further, a Component Carrier (CC) may be referred to as a carrier frequency, a cell, a frequency carrier, or the like.

The terms “system” and “network” used in the present disclosure can be used interchangeably.

Furthermore, information, parameters, and the like described in the present disclosure may be represented by an absolute value, may be represented by a relative value from a predetermined value, or may be represented by corresponding other information. For example, a radio resource may be indicated using an index.

Names used for the above parameters are not restrictive names in any respect. In addition, formulas and the like using these parameters may be different from those explicitly disclosed in the present disclosure. Since the various channels (for example, a PUCCH, a PDCCH, or the like) and information elements can be identified by any suitable names, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. A gNB 100 may also be referred to with a term such as a macro cell, a small cell, a femtocell, or a pico cell.

The gNB 100 can accommodate one or more (for example, three) cells (also referred to as sectors). In a configuration in which the gNB 100 accommodates a plurality of cells, the entire coverage area of the gNB 100 can be divided into a plurality of smaller areas. In each of the smaller areas, a communication service can be provided by a base station subsystem (for example, a small base station for indoor use (remote radio head: RRH)).

The term “cell” or “sector” refers to a part or all of the coverage area of at least one of a gNB 100 and a base station subsystem that performs a communication service in this coverage.

In the present disclosure, the terms such as “mobile station (Mobile Station: MS)”, “user terminal”, “user equipment (User Equipment: UE)”, and “terminal” can be used interchangeably.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of a gNB 100 and a mobile station may be called a transmitting device, a receiving device, a communication device, or the like. Note that at least one of a gNB 100 and a mobile station may be a device mounted on a moving body, a moving body itself, or the like. The moving body may be a vehicle (for example, a car, an airplane, or the like), an unmanned moving body (a drone, a self-driving car, or the like), or a robot (manned type or unmanned type). At least one of a gNB 100 and a mobile station also includes a device that does not necessarily move during the communication operation. For example, at least one of a gNB 100 and a mobile station may be an Internet of Things (IoT) device such as a sensor.

Also, a gNB 100 in the present disclosure may be read as meaning a mobile station (user terminal, hereinafter, the same). For example, each aspect/embodiment of the present disclosure may be applied to a configuration in which communication between a gNB 100 and a mobile station is replaced with communication between a plurality of mobile stations (which may be called Device-to-Device (D2D), Vehicle-to-Everything (V2X), or the like). In this case, the mobile station may have the function of a gNB 100. In addition, words such as “uplink” and “downlink” may also be read as meaning words corresponding to inter-terminal communication (for example, “side”). For example, an uplink channel, a downlink channel, or the like may be read as meaning a side channel.

Similarly, the mobile station in the present disclosure may be read as meaning a gNB 100. In this case, the gNB 100 may have the function of the mobile station. A radio frame may be composed of one or more frames in the time domain. Each of the one or more frames in the time domain may be referred to as a subframe. A subframe may be further composed of one or more slots in the time domain. The subframe may be a fixed time length (for example, 1 ms) independent of the numerology.

The numerology may be a communication parameter applied to at least one of transmission and reception of a certain signal or channel. The numerology may indicate at least one of, for example, subcarrier spacing (SCS), bandwidth, symbol length, cyclic prefix length, transmission time interval (TTI), the number of symbols per TTI, radio frame configuration, a specific filtering process performed by a transceiver in the frequency domain, a specific windowing process performed by a transceiver in the time domain, and the like.

A slot may be composed of one or more symbols (Orthogonal Frequency Division Multiplexing (OFDM)) symbols, Single Carrier Frequency Division Multiple Access (SC-FDMA) symbols, and the like) in the time domain. A slot may be a unit of time based on the numerology.

A slot may include a plurality of minislots. Each minislot may be composed of one or more symbols in the time domain. A minislot may be called a subslot. A minislot may be composed of fewer symbols than slots. A PDSCH (or PUSCH) transmitted in time units greater than the minislot may be referred to as a PDSCH (or PUSCH) mapping type A. A PDSCH (or PUSCH) transmitted using a minislot may be referred to as a PDSCH (or PUSCH) mapping type B.

Each of a radio frame, subframe, slot, minislot, and symbol represents a time unit for transmitting a signal. A radio frame, subframe, slot, minislot, and symbol may have respectively different names corresponding to them.

For example, one subframe may be called a transmission time interval (TTI), a plurality of consecutive subframes may be called a TTI, and one slot or one minislot may be called a TTI. That is, at least one of the subframe and TTI may be a subframe (1 ms) in the existing LTE, a period shorter than 1 ms (for example, 1 to 13 symbols), or a period longer than 1 ms. Note that, a unit representing TTI may be called a slot, a minislot, or the like instead of a subframe.

Here, a TTI refers to the minimum time unit of scheduling in radio communication, for example. For example, in the LTE system, the gNB 100 performs scheduling for allocating radio resources (frequency bandwidth, transmission power, and the like that can be used in each user terminal) to each user terminal in units of TTI. The definition of TTI is not limited to this.

A TTI may be a transmission time unit such as a channel-coded data packet (transport block), a code block, or a code word, or may be a processing unit such as scheduling or link adaptation. When a TTI is given, a time interval (for example, the number of symbols) in which a transport block, a code block, a code word, and the like are actually mapped may be shorter than TTI.

When one slot or one minislot is called a TTI, one or more TTIs (that is, one or more slots or one or more minislots) may be the minimum time unit of the scheduling. The number of slots (minislot number) constituting the minimum time unit of the scheduling may be controlled.

A TTI having a time length of 1 ms may be referred to as an ordinary TTI (TTI in LTE Rel. 8-12), a normal TTI, a long TTI, an ordinary subframe, a normal subframe, a long subframe, a slot, and the like. A TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, and the like) may be read as meaning a TTI having a time length exceeding 1 ms, and a short TTI (for example, shortened TTI) may be read as meaning a TTI having a TTI length of less than a TTI length of a long TTI and a TTI length of 1 ms or more.

A resource block (RB) is a resource allocation unit in the time domain and the frequency domain, and may include one or more consecutive subcarriers in the frequency domain. The number of subcarriers included in the RB may be the same regardless of the numerology, and may be 12, for example. The number of subcarriers included in the RB may be determined based on the numerology.

Further, the time domain of an RB may include one or more symbols, and may have a length of 1 slot, 1 minislot, 1 subframe, or 1 TTI. Each TTI, subframe, or the like may be composed of one or more resource blocks.

Note that, one or more RBs may be called a Physical Resource Block (PRB), a Sub-Carrier Group (SCG), a resource element group (REG), a PRB pair, a RB pair, and the like.

A resource block may be configured by one or more Resource Elements (REs). For example, one RE may be a radio resource domain of one subcarrier and one symbol.

A Bandwidth Part (BWP) (which may be called a partial bandwidth or the like) may represent a subset of consecutive common resource blocks (RBs) for a certain numerology in a certain carrier. Here, the common RB may be specified by an index of the RB based on the common reference point of the carrier. A PRB may be defined in a certain BWP and numbered within that BWP.

A BWP may include a BWP for UL (UL BWP) and a BWP for DL (DL BWP). One or more BWPs may be configured in one carrier for the UE.

At least one of the configured BWPs may be active, and the UE does not have to expect to transmit and receive predetermined signals/channels outside the active BWP. Note that “cell”, “carrier”, and the like in this disclosure may be read as meaning “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in RBs, and the number of symbols included in a TTI, a symbol length, the Cyclic Prefix (CP) length, and the like can be changed in various manner.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be read as meaning “access”. In the present disclosure, two elements can be “connected” or “coupled” to each other by using at least one of one or more wires, one or more cables, and one or more printed electrical connections, and as some non-limiting and non-exhaustive examples, by using electromagnetic energy having wavelengths in the radio frequency domain, a microwave region, and a light (both visible and invisible) region, and the like.

A reference signal may be abbreviated as RS and may be called a Pilot according to applicable standards.

As used in the present disclosure, the phrase “based on” does not mean “based only on” unless explicitly stated otherwise. In other words, the phrase “based on” means both “based only on” and “based at least on”.

“Means” in the configuration of each device above may be replaced with “unit”, “circuit”, “device”, and the like.

Any reference to elements using a designation such as “first”, “second”, or the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element has to precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

As used in this disclosure, the term “determining” may encompass a wide variety of actions. “determining” includes deeming that determining has been performed by, for example, judging, calculating, computing, processing, deriving, investigating, searching (looking up, search, inquiry) (for example, searching in a table, database, or another data structure), ascertaining, and the like. In addition, “determining” can include deeming that determining has been performed by receiving (for example, receiving information), transmitting (for example, transmitting information), inputting (input), outputting (output), access (accessing) (for example, accessing data in a memory), and the like. In addition, “determining” can include deeming that determining has been performed by resolving, selecting, choosing, establishing, comparing, and the like. That is, “determining” may include deeming that “determining” regarding some action has been performed. Moreover, “determining” may be read as meaning “assuming”, “expecting”, “considering”, and the like.

In the present disclosure, the wording “A and B are different” may mean “A and B are different from each other”. It should be noted that the wording may mean “A and B are each different from C”. Terms such as “separate”, “couple”, or the like may also be interpreted in the same manner as “different”.

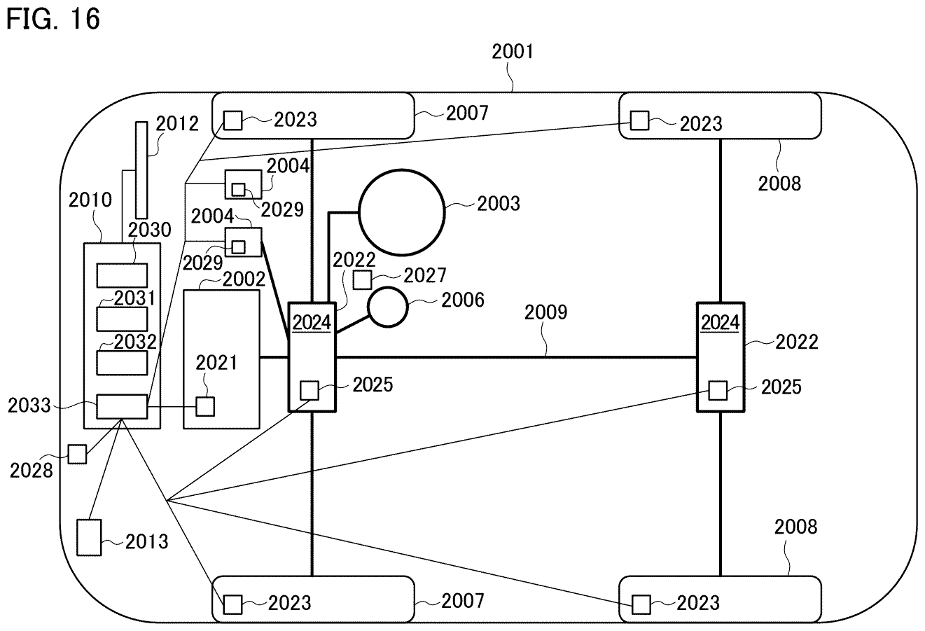

FIG. 16 shows a configuration example of a vehicle 2001. As shown in FIG. 16, the vehicle 2001 includes a drive 2002, a steering 2003, an accelerator pedal 2004, a brake pedal 2005, a shift lever 2006, left and right front wheels 2007, left and right rear wheels 2008, an axle 2009, an electronic controller 2010, various sensors 2021 to 2029, an information service unit 2012, and a communication module 2013.

Examples of the drive 2002 include, an engine, a motor, and a hybrid of an engine and a motor.

The steering 2003 includes at least a steering wheel (also called a handle) and steers at least one of the front and rear wheels based on an operation of a steering wheel operated by a user.

### The Electronic Controller 2010 Includes a

microprocessor 2031, a memory (ROM, RAM) 2032, and a communication port (IO port) 2033. The electronic controller 2010 receives signals from various sensors 2021 to 2027 provided in the vehicle. The electronic controller 2010 may be called an ECU (Electronic Control Unit).

The signals from the various sensors 2021 to 2028 include a current signal from a current sensor 2021 for sensing current of a motor, a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like.

The information service unit 2012 includes various devices such as a car navigation system, an audio system, a speaker, a television, and a radio for providing various information such as driving information, traffic information, and entertainment information, and one or more ECUs for controlling these devices. The information service unit 2012 provides various multimedia information and multimedia services to an occupant of the vehicle 1 by using information acquired from an external device through a communication module 2013 and the like.

A driver support system unit 2030 comprises various devices such as a millimeter wave radar, a light detection and ranging (LiDAR), a camera, a positioning locator (for example, GNSS), map information (for example, high-definition (HD) maps, autonomous vehicle (AV) maps, and the like), a gyroscopic system (for example, an inertial measurement unit (IMU), an inertial navigation system (INS), and the like), an artificial intelligence (AI) chip, and an AI processor for providing functions to prevent accidents or reduce a driving load of a driver, and one or more ECUs for controlling these devices. Further, the driver support system unit 2030 transmits and receives various kinds of information through the communication module 2013 to realize a driver support function or an automatic driving function.

The communication module 2013 can communicate with the microprocessor 2031 and components of the vehicle 1 through a communication port. For example, the communication module 2013 transmits and receives data through the communication port 2033 to and from the drive 2002, steering 2003, accelerator pedal 2004, brake pedal 2005, shift lever 2006, left and right front wheels 2007, left and right rear wheels 2008, axle 2009, microprocessor 2031 in the electronic control 2010, memory (ROM, RAM) 2032, and sensor 2021 to 2028.

The communication module 2013 is a communication device that can be controlled by the microprocessor 2031 of the electronic controller 2010 and can communicate with an external device. For example, The communication module 2013 transmits and receives various kinds of information via radio communication with the external device. The communication module 2013 may be placed inside or outside the electronic control unit 2010. Examples of the external device may include a gNB 100, a mobile station, and the like.

The communication module 2013 transmits a current signal coming from a current sensor and input to the electronic controller 2010 to an external device via radio communication. Further, the communication module 2013 transmits a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like input to the electronic controller 2010 to an external device via radio communication.

The communication module 2013 receives various information (traffic information, signal information, inter-vehicle information, and the like.) transmitted from the external device and displays on the information service unit 2012 provided in the vehicle. Further, the communication module 2013 stores various information received from the external device in a memory 2032 usable by the microprocessor 2031. Based on the information stored in the memory 2032, the microprocessor 2031 may control the drive 2002, the steering 2003, the accelerator pedal 2004, the brake pedal 2005, the shift lever 2006, the left and right front wheels 2007, the left and right rear wheels 2008, the axle 2009, the sensors 2021 to 2028, and the like provided in the vehicle 2001.

### Note

The terminal of the present embodiment may be configured as the terminal illustrated in the following sections. Further, the following base station may be implemented.

### (Section 1)

A terminal including:
a control unit that configures information for configuring a parameter related to a transmission period of DL and UL data transmitted between a terminal and a base station during a predetermined period; and
a transmission unit that transmits the information to the base station.

### (Section 2)

The terminal according to the section 1, wherein
the transmission unit transmits to the base station, at least one of an indication to start transmission of the DL and the UL data at the start of the transmission period and an indication to end transmission of the DL and the UL data at the end of the transmission period.

### (Section 3)

The terminal according to the section 1 or 2, wherein
the control unit includes a timer that manages the transmission period.

### (Section 4)

The terminal according to the section 1 or 2, wherein
the control unit includes a timer that manages the transmission period, and autonomously adjusts an intermittent reception cycle in the transmission period when the timer expires.

### (Section 5)

The terminal according to the section 1 or 2, wherein
the control unit adjusts an intermittent reception cycle in the transmission period based on MAC CE transmitted from the base station when a timer that manages the transmission period expires.

### (Section 6)

A base station including:
a reception unit that receives information for configuring a parameter related to a transmission period of DL and UL data transmitted between a terminal and a base station during a predetermined period; and
a control unit that configures the parameter based on the information.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 NG-RAN
40 Core network
50 AMF
51 Communication unit
52 Transmission unit
53 Control unit
100 gNB (Radio base station)
100X NTN gateway
110 Radio communication unit
120 Reception unit
140 Control unit
200 UE (head-mounted terminal)
210 Radio communication unit
220 Transmission unit
240 Control unit
1001 Processor
1002 Memory
1003 Storage
1004 Communication device
1005 Input device
1006 Output device
1007 Bus
2001 Vehicle
2002 Drive unit
2003 Steering unit
2004 Axel pedal
2005 Brake pedal
2006 Shift lever
2007 Left and right front wheels
2008 Left and right rear wheels
2009 Axles
2010 Electronic control unit
2012 Information service unit
2013 Communication module
2021 Current sensor
2022 Rotational speed sensor
2023 Air pressure sensor
2024 Vehicle speed sensor
2025 Acceleration sensor
2026 Brake pedal sensor
2027 Shift lever sensor
2028 Object detection sensor
2029 Axel pedal sensor
2030 Operation support system unit
2031 Microprocessor
2032 Memory (ROM, RAM)
2033 Communication port

1. A terminal comprising:
a control unit that configures information for configuring a parameter related to a transmission period of DL and UL data transmitted between a terminal and a base station during a predetermined period; and
a transmission unit that transmits the information to the base station.

2. The terminal according to claim 1, wherein
the transmission unit transmits to the base station, at least one of an indication to start transmission of the DL and the UL data at the start of the transmission period and an indication to end transmission of the DL and the UL data at the end of the transmission period.

3. The terminal according to claim 1, wherein
the control unit includes a timer that manages the transmission period.

4. The terminal according to claim 1, wherein
the control unit includes a timer that manages the transmission period, and autonomously adjusts an intermittent reception cycle in the transmission period when the timer expires.

5. The terminal according to claim 1, wherein
the control unit adjusts an intermittent reception cycle in the transmission period based on MAC CE transmitted from the base station when a timer that manages the transmission period expires.

6. A base station comprising:
a reception unit that receives information for configuring a parameter related to a transmission period of DL and UL data transmitted between a terminal and a base station during a predetermined period; and
a control unit that configures the parameter based on the information.
